(19) United States
(12) Patent Application Publication
(10) Pub. No.: US 2018/0306192 A1
(43) Pub. Date: Oct. 25, 2018

(54) DELIVERY DEVICE FOR A VACUUM DISTILLATION PLANT

(71) Applicant: Holger Blum, Teufen (CH)

(72) Inventor: Holger Blum, Teufen (CH)

(21) Appl. No.: 15/774,995

(22) PCT Filed: Nov. 10, 2016
(86) PCT No.: PCT/EP2016/077309

§ 371 Date: May 9, 2018

(30) Foreign Application Priority Data
Nov. 11, 2015 (DE) 20 2015 106 097.1

(51) Int. Cl. F04D 13/02; B01D 3/10; B01D 3/42; F16K 15/02; F16K 17/04; F16K 27/02; F04D 15/00

(52) U.S. Cl. CPC F04D 13/024; B01D 3/10; B01D 3/42; F04D 15/0022; F16K 17/0413; F16K 27/0209; F16K 15/028

(57) ABSTRACT

The invention relates to a conveyor device for a vacuum distillation plant for substance mixtures that polymerize and/or decompose readily, in particular acrolein, in which plant an intermediate product formed in a preliminary stage is delivered by means of a pump into a vacuum distillation column (37). The invention is characterized in that the pump is a hermetically sealed centrifugal pump (31) having a magnetic coupling, and in that a pressure holding control valve (34), which is configured to adjust the throughput of the centrifugal pump (31) to a predetermined value, is provided between the centrifugal pump (31) and the vacuum distillation column (37).

The invention relates to a conveyor device for a vacuum distillation plant for readily decomposable and/or polymerizing mixtures, in particular acrolein, in which an intermediate product formed in a precursor stage, is conveyed by a pump into a vacuum distillation column.

From EP 0759 132 A1 a pressure holding valve is known, in which a displaceable valve piston is pressed against the upper side of a housing valve seat, to the underside of which a housing inlet channel leads and at the top of the housing an outlet passage is connected, and in which between the valve piston and an adjustable pressure spring acting on it, a separation membrane which is tightly clamped between the valve housing containing the valve piston and a spring mandrel containing a compression spring. In the valve housing space above the valve seat, a guide disc is arranged slidably leading the valve piston, which guide disc forms together with the cylindrical guide shaft of the valve piston a narrow annular gap extending over the entire shaft circumference and tightly covers up to this annular gap the underside of the separation membrane against the housing outlet passage valve seat top wherein the radial width of the annular gap is dimensioned at most so large that the annular gap of the medium, depending on its viscosity, can only be flown through it with a throttled effectively damped, slowed-down flow.

Conventional pressure holding valves, such as the valve of EP 0759132 A1, fail due to the tight material fits after a short time, when the pumped medium contains smallest amounts of suspended solids or when the medium is a readily decomposable and/or polymerizing mixtures, which is particularly the case of acrolein, which is processed in plants in which an intermediate product formed in a precursor stage is conveyed by a pump into a vacuum distillation column.

Liquid crude acrolein stabilized with phenolic inhibitors tends to accelerate the breakdown of polymerization products when rubbed between metallic moving surfaces. This is the case when acrolein is pumped by a pump in which the acetoin comes in contact with metallic parts of the pump or when the acrolein is passed through control valves having metallic closure contact surfaces. Such pumps and control valves are still used in plants for the pure extraction of acrolein by vacuum distillation. As a result, the trouble-free operation of such processing installations often lasts only a few weeks. Since acrolein is a poisonous, highly lachrymatory hazardous material, the maintenance of disturbed plants that process acrolein, is associated with cumbersome and tedious and therefore costly operations.

The invention has for its object to provide a conveyor device for a vacuum distillation plant, which allows a long, trouble-free operating time despite processing of easily decomposed and/or polymerizing mixtures of substances, in particular acrolein.

For this purpose, the conveyor device according to the invention for a vacuum distillation plant for readily decomposable and/or polymerizing mixtures, in particular acrolein, in which an intermediate product formed in a precursor stage is pumped by a pump into a vacuum distillation column, is characterized in that the pump is a hermetically sealed centrifugal pump having a magnetic coupling, and that between the radial centrifugal pump and the vacuum distillation column, a pressure holding and regulating valve is provided which is designed to adjust the flow rate of the radial centrifugal pump to a predetermined value.

The use of a hermetically sealed radial centrifugal pump has the advantage that it has no mechanical drive shaft and therefore neither a stuffing box nor a mechanical seal yet another type of shaft passage to the drive motor, so that the formation of polymer substance by the contact of the pumped medium with metallic components of the pump is reduced. On the other hand, however, in the case of a centrifugal pump there is the risk that, when the centrifugal pump is stationary or running, the condensate is sucked in without regulation directly from the precursor stage into the vacuum distillation column. This problem is solved in the conveyor device according to the invention in that the pressure holding and regulating valve between the radial centrifugal pump and the vacuum distillation column is provided which ensures a constant flow by the pressure holding and regulating valve during operation and blocks the flow from the centrifugal pump to the vacuum distillation column when the pump is stationary. The conveyor device according to the invention is thus a simple device for a vacuum distillation method and the like to obtain pure acrolein with long, trouble-free uptime.

According to an advantageous embodiment, the conveyor device according to the invention, wherein the predetermined relationship between the dimensionless delivery height H/Ho[mWS/1 mWS] and dimensionless flow rate Q/Qo[m³/h/1 m³/h] in a centrifugal pump is:

{H/Ho}=C2−C3*(Q/Qo)² (Formula II)

and the relationship between the dimensionless delivery height H/Ho [m WS/1 mWS] and dimensionless delivery rate Q/Qo [m³/h/1 m³/h] at the pressure holding and regulating valve (34) is:

{H/Ho}={C1*(Q/Qo)}^{0,333} (Formula III)

is characterized in that by the choice of the constant C1, the intersection between the curves according to Formula II and Formula III is at the point corresponding to the desired flow rate of the mixture. Through these relationships between the delivery levels and the delivery rates at the pressure holding and regulating valve or in the radial circuit pump, it is possible in an advantageous manner to determine the desired flow rate and set by the choice of the constant C1.

According to an advantageous embodiment, the conveyor device according to the invention is characterized in that a rotameter is arranged between the radial centrifugal pump and the pressure holding and regulating valve. By the rotameter it can be continuously checked in an advantageous manner, whether the flow conditions from the radial centrifugal pump to the vacuum distillation column correspond to the prepared conditions, so that, if this is not the case, countermeasures can be taken in a simple manner, for example by adjusting the pump power or the flow rate through the holding and regulating valve.

According to a further advantageous embodiment, the conveyor device according to the invention is characterized in that the precursor stage of the vacuum distillation plant comprises a cleavage reactor, a condenser downstream of the cleavage reactor and, downstream of the condenser a condensate collecting tank which is connected to an inlet of the radial centrifugal pump. By this configuration of the preliminary stage of the vacuum distillation system it is achieved in an advantageous manner that the supply of the radial centrifugal pump with condensate is ensured at any time and regardless of the condensate level in the collecting tank.

According to a further advantageous embodiment, the conveyor device according to the invention is characterized in that the pressure holding and regulating valve comprises a cylindrical valve housing having an upper side, in which a central inlet bore is provided with a diameter d1, and with a lower side, in which an inner bore is provided, whose diameter d2 is greater than the diameter of the inlet bore and which forms an outlet of the pressure holding and regulating valve, a closure piston with a top whose diameter d3 is smaller than the diameter of the inner bore and larger than the diameter of the inlet bore, a freely movable, circular sealing washer made of an elastomer between the sealing piston and an inner sealing surface, which is formed between the inner bore and the inlet bore on an inner side of the valve housing, and by a compression spring which is supported in the inner bore and presses the sealing washer through the closure piston against the inner sealing surface.

The pressure holding and regulating valve is largely insensitive to the presence of suspended substances in the flowing medium. The pressure holding and regulating valve has a self-cleaning effect, because, since all moving parts can move freely axially and laterally, deposits or accumulations of suspended substances are always flushed out with the pumped medium. Therefore, the use of pressure holding and regulating valve according to the invention is particularly advantageous if the pumped medium is excreting unsolvable solids by polymerization.

In contrast to the conventional pressure relief valve of EP 0759 132 A1, which contains many accurately fitted single part therefore prone to failure, the present pressure holding and regulating valve contains only two freely movable metal parts and a floating, i.e. freely moving elastomer seal, which can be easily replaced just like the freely moving parts without the use of special tools.

According to a further advantageous embodiment, the conveyor device according to the invention is characterized in that the sealing disc has a diameter d3 which is greater than the diameter of the inlet bore plus the radial extent of the sealing surface, and which is smaller than the diameter of the upper part of the closure pistons. Due to these dimensions of sealing disk it is advantageously ensured that the sealing disc covers the inlet bore in any case, regardless of the lateral position of the sealing washer relative to the inlet bore.

According to a further advantageous embodiment of the invention pressure holding and regulating valve characterized in that the upper side and the underside of the valve housing are formed as plane sealing surfaces. Thus, the top and bottom can be used as sealing surfaces against connection components in an advantageous manner when installing the pressure holding and regulating valve.

According to a further advantageous embodiment, the conveyor device according to the invention is characterized in that a gap formed between the upper part of the closure piston and the inner bore has a cross-sectional area which corresponds to the cross-sectional area of the inlet bore. This ensures in an advantageous manner that there is no bottleneck in the pressure holding and regulating valve for the flow of the medium to be conveyed.

According to a further advantageous embodiment, the conveyor device according to the invention is characterized in that the compression spring is supported in the inner bore by a Seeger ring arranged over a groove in the inner bore. Such a holder for the compression spring has the advantage that the compression spring can be easily and quickly replaced if necessary.

According to a further advantageous embodiment, the conveyor device according to the invention is characterized in that, between the Seeger-ring and the compression spring, at least one clamping ring is arranged for adjusting the bias of the compression spring. The clamping rings are advantageously a simple means to change the bias of the compression spring to adjust the spring force acting on the gasket to the respective needs.

Due to the dimensioning of the components of the pressure holding and regulating valve according to the invention, the valve housing and the closure piston can be made of metal, without this adversely affecting the formation of deposits in the medium to be delivered. The pressure holding and regulating valve has no metallic closure contact surfaces and allows trouble-free operating times of more than one year.

Further advantages, features and applications of the present invention will become apparent from the following description taken in conjunction with embodiments shown in the drawings.

In the description, the claims and the drawing, the terms and associated reference numerals used in the list of reference numerals below are used. In the drawings:

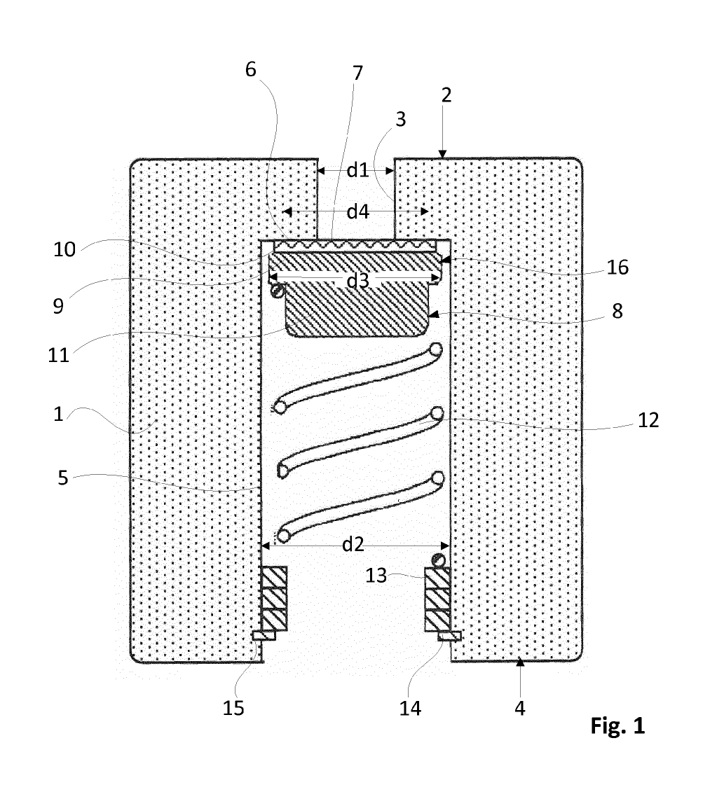

FIG. 1 shows a section through an embodiment of a pressure holding and regulating valve which is used in the conveyor device according to the invention;

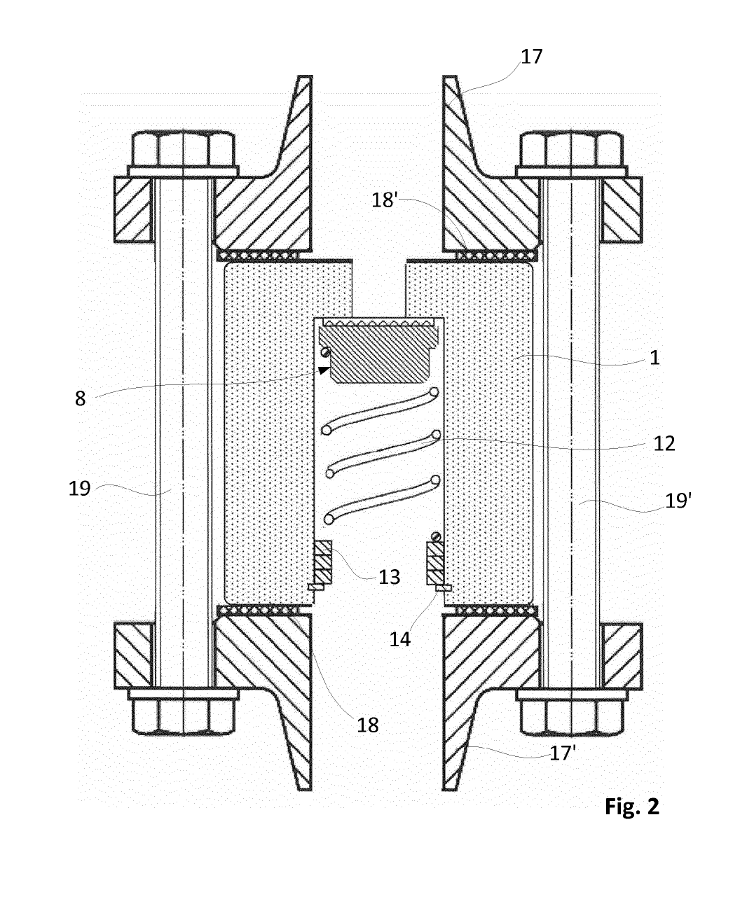

FIG. 2 shows a section through an installation of the pressure holding and regulating valve of FIG. 1 in a process plant;

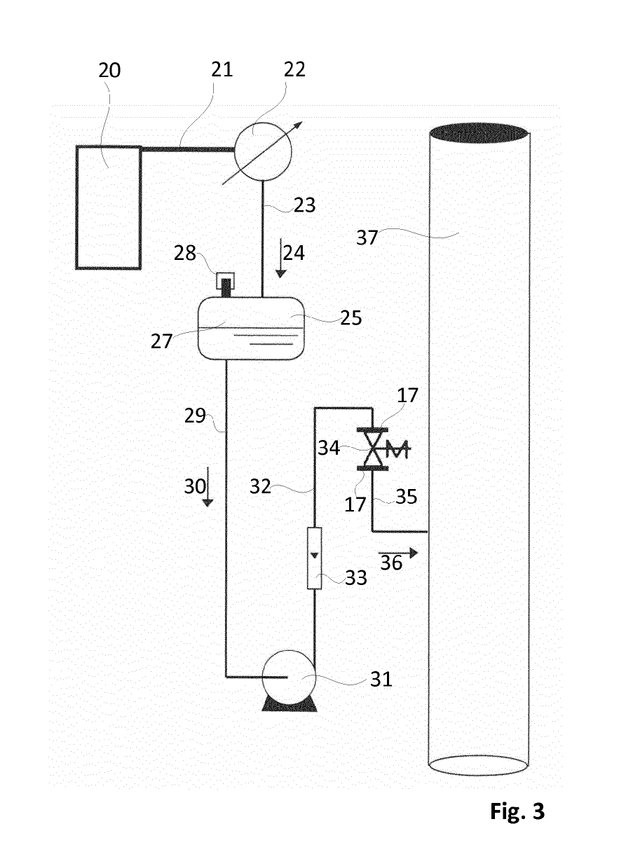

FIG. 3 is a schematic representation of a vacuum distillation unit for easily decomposable and/or polymerizing mixtures, in particular acrolein; and

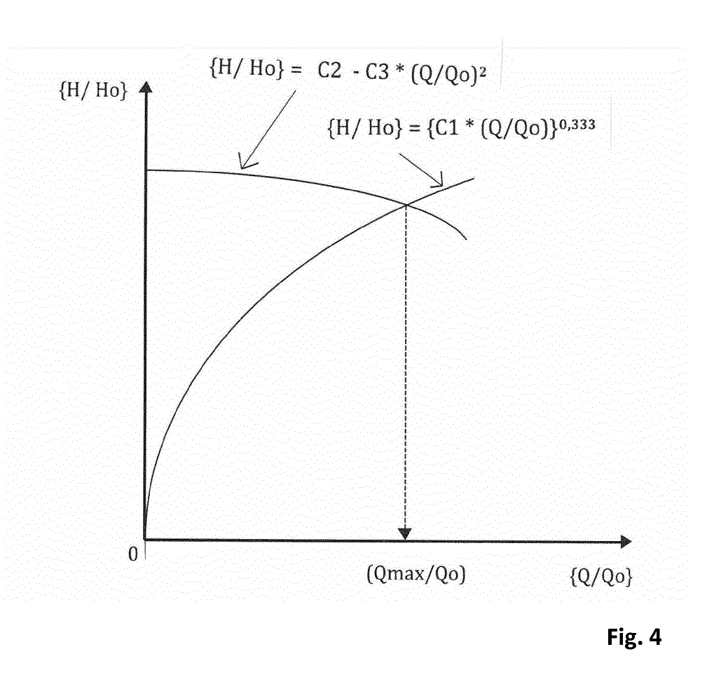

FIG. 4 is a graph showing the ratios of hydraulic pressure and hydraulic flow rate in a Radtalkreiselpumpe and a pressure holding and regulating valve.

First of all, a pressure holding and regulating valve will be described with reference to FIGS. 1 and 2, which is used in the conveyor device according to the invention for a vacuum distillation plant.

According to FIG. 1 the pressure holding and regulating valve according to the invention has a cylindrical, metallic valve housing 1 with a top 2, in which a central inlet bore 3 with a diameter d1 is located. The valve housing 1 comprises an inner bore 5 whose diameter d2 is greater than that of the diameter of the inlet bore 3 and which forms an outlet of the pressure holding and regulating valve. The valve housing 1 has an underside 4, which, like the upper side 2, is designed as a flat surface and thus can be used as sealing surfaces against connecting components during installation of the pressure retaining and regulating valve.

In the valve housing 1 there is located between the inner bore 5 and the inlet bore 3, a cylindrical, planar, inner sealing surface 6 as a transition between the inner bore 5 and the entrance hole 3. A freely movable, circular sealing disk 7 made of an elastomer, is arranged between a closure piston 8 and the sealing surface 6. As FIG. 1 shows, the diameter d3 of a cylindrical upper part 9 of the closure piston 8 is smaller than the diameter of the inner bore 5 but larger than the diameter of the inlet bore 3.

The sealing washer 7 has a diameter d3 which is larger than the diameter of the Inlet bore plus the radial extent of the sealing surface. 6 In addition, the diameter d3 of the sealing disk 7 is smaller than the diameter d3 of the upper part 9 of the closure piston 8. The sealing disk 7 thus closes the inlet bore 3 independently of the lateral position of the sealing disk 7 when the closure piston 8 presses the sealing disk 7 against the sealing surface 6. The closure piston 8 has rounded edges 10. A cylindrical lower part 11 of the closure pistons 8 has a smaller diameter d4 than the inner diameter of a compression spring 12, which presses the closure piston 8 via the sealing disc 7 against the sealing surface 6.

The compression spring 12 has free passage gaps between the turns. The outer diameter of the compression spring 12 is smaller than the diameter d2 of the inner bore 5. The compression spring 12 is biased by one or more clamping rings 13. The clamping rings 13 sit with h6-fit in the inner bore 5, which has a H7-fit. A Seeger-ring 14, which is clamped in a groove 15, keeps the clamping rings 13 pressed by compression against the compression spring 12. In the installed state, the compression spring 12 exerts a force on the sealing disk 7 by pre-stressing it by means of the closure piston 8 whereby the inlet bore 3 is closed in a liquid-tight manner. The compressive force of the compression spring 12 is calculated to the spring constant times compression in mm according to the following Formula I:

$$\begin{matrix}Spring constant \\ ( N \text{/} mm )\end{matrix} = \frac{\begin{matrix}material constant ( N \text{/} {mm}^{2} ) * \\ {( diameter of spring in mm )}^{4}\end{matrix}}{\begin{matrix}Number of truns * \\ {( diameter of spring in mm )}^{3}\end{matrix}} \qquad ( Formula I )$$

As can be seen, there are several free variables to achieve the desired spring tension. The hydraulic pressure of the liquid inflowing at the inlet bore 3 causes the sealing disc 7 to lift off from the plane inner sealing surface 6 against the spring force of the compression spring 12 and that the liquid flow entering the inlet bore 3 can flow past the closure piston 8, through a gap 16 between the upper part the closure piston 8 and the inner bore 5 and between the turns of the compression spring 12 into the inner bore 5.

Preferably, the gap 16 has a cross-sectional area corresponding to the cross-sectional area of the Inlet bore 3. During operation of the pressure holding and regulating valve according to the invention, only the spring 12 and the closure piston 8 are moving. The sealing disc 7 remains between the closure piston 8 and the sealing surface 6.

The compression spring 12, the closure piston 8 and the sealing disc 7 may be in the exit bore 5 can move radially and arrange themselves, as experiments show, in free play centrically in the inner bore 5. Therefore, the pressure holding and regulating valve according to the invention can advantageously be used on seagoing vessels, where the ordinate axis performs a wobbling motion due to the swell.

The pressure holding and regulating valve according to FIG. 1 can, as shown in FIG. 2, be installed between two DIN flanges 17, 17′ using flat gaskets 18, 18′. If the flanges 17, 17′ are parts of two shut-off valves, the pressure holding and regulating valve according to the invention can be easily dis-installed during operation by locking both valves above and below the pressure holding and regulating valve of FIG. 1 and loosening bolts 19, 19′. The dis-installed pressure holding and regulating valve is dis-assembled by relaxing the Seeger-ring 14 and another compression spring 12 or an additional clamping ring 13 can be replaced in a short time.

In experiments with the pressure holding and regulating valve of FIG. 1, the relationship between the hydrostatic pressure at the inlet bore 3 and the hydraulic flow rate of the flow through the pressure holding and regulating valve was examined and found that the ratio of two pressures equal to the third root of the ratio of the respective two flow rates.

If H/Ho[mWS/1 mWS] denotes the hydrostatic pressure in dimensionless form and Q/Qo [m³/h/1 m³/h] denoted the hydraulic flow capacity in dimensionless form, the following formula applies to the pressure holding and regulating valve according to the invention:

{H/Ho}=C2−C3*(Q/Qo)² (Formula II)

wherein:
H=hydraulic pressure

### Ho=1 mHS

C1=Constant of the pressure holding and regulating valve
Q=Hydraulic flow
Qo=1 m³/h

With reference to the conveyor device described below, the advantageous use of the pressure holding and regulating valve is explained, where a typical example of a vacuum distillation unit for readily decomposable and/or polymerizing mixtures is a plant for the synthesis of acrolein, CAS No. 107-02-8, by dehydration of glycerol, CAS No. 56-81-5.

The vacuum distillation unit for the synthesis of acrolein according to FIG. 3 comprises in a precursor stage for the preparation of an intermediate product, a glycerol cleavage reactor 20, a condenser 22, and a condensate collecting tank 25. From the glycerol cleavage reactor 20 emerges a hot reaction gas consisting of acrolein, acetol CAS No. 111-09-6, acetic acid CAS No. 64-19-7, water and low volatility substances. The reaction gas is passed through a gas line 21 into the condenser 22 and is completely liquefied there at 0° C. The cold liquid condensate 26 passes through a condensate line 23 into the condensate collecting tank 25. The condensate 26 may have a different high level 27, depending on the volume flow of the reaction gas in the collecting tank 25. A polymerization inhibitor such as hydroquinone can be added to the condensate collecting tank 25 by a filling stub 28.

The condensate 26 stabilized by means of the polymerization inhibitor passes via a delivery line 29 into a suction port of a hermetically sealed centrifugal pump 31. The radial centrifugal pump 31 has a magnetic coupling and no mechanical drive shaft and therefore has neither a stuffing box nor a mechanical seal nor another type of shaft passage to the drive motor.

On an outlet flange of the radial centrifugal pump 31, a delivery line 32 is connected. In the delivery line 32, a rotameter 33, a variable area flowmeter, installed. Between the feed line 32 and the vacuum line 35, the pressure holding and regulating valve 34 according to the invention is installed.

The vacuum line 35 leads to a vacuum distillation column 37 in which pure acrolein is obtained as a readily volatile top product, while the less volatile substances such as water, acetol, acetic acid and other low-volatiles are withdrawn at the bottom of the column.

The pressure holding and regulating valve 34 has the effect that the condensate 26 is not sucked into the vacuum distillation column 37 in an unregulated manner when the radial centrifugal pump 31 is stationary or running. In addition, the delivery rate of the radial centrifugal pump 31 is adjusted as follows to a constant volume flow Qmax.

The relationship between the dimensionless height H/Ho[mWS/1 mWS] and the dimensionless delivery rate Q/Qo[m³/h/1 m³/h] in a radial centrifugal pump are:

{H/Ho}=C2−C3*(Q/Qo)² (Formula II)

wherein C2 and C3 are constants specific to the radial centrifugal pump.

For the pressure holding and regulating valve 34 the relationship between the dimensionless delivery height H/Ho[mWS/1 mWS] and dimensionless delivery rate Q/Qo[m³/h/1 m³/h] at the pressure holding and regulating valve (34) is as mentioned above:

{H/Ho}={C1*(Q/Qo)}^{0,333} (Formula III)

By stetting that Formula II equals Formula III it follows that:

C2−C3*(Q/Qo)²={C1*(Q/Qo)}^{0,333}

And thereby

C2={C1*(Q/Qo)}0,333+C3*(Qmax/Qo} (Formula IV)

This equation, according to Formula IV has only one positive solution for Qmax. Since C1 depends only from the spring constant and the bias of the compression spring 12, i.e. of the number of clamping rings 13, which are installed in the pressure holding and regulating valve 34 according to the invention, for each radial centrifugal pump whose constants C2 and C3 are fixed, a suitable Qmax for the inflow to the vacuum distillation column 37 can be set and maintained.

The relationship between dimensionless delivery height H/Ho[mWS/1 mWS] and dimensionless delivery rate Q/Qo[m³/h/1 m³/h] in a radial centrifugal pump and the relationship between dimensionless height H/Ho[mWS/1 mWS] and dimensionless delivery rate Q/Qo[m³/h/1 m³/h] in the pressure holding and regulating valve 34 is shown graphically in FIG. 4, with the value Qmax falling on the intersection between the two curves.

The following Tables 1 to 3 are examples of the influence of the constant C1 on the maximum flow rate Qmax of the radial centrifugal pump. The larger the constant C1, the smaller becomes the value to which the maximum flow passage of the centrifugal pump is restricted. The intersection point at which Qmax lies can be theoretically determined according to the above equation according to Formula IV, it can also be determined empirically from tables such as Tables 1 to 3.

TABLE 1
Prameter

| | | |
|---|---|---|
| C1 | | 500 |
| C2 | | 15 |
| C3 | | 1 |
| Delta | Step width Q/Qo | 0.1 |

| Q/Qo | H/Ho-Pump | H/Ho-DHV | |
|---|---|---|---|
| 0 | 15.0 | 0.00 | |
| 0.1 | 14.99 | 3.68 | |
| 0.2 | 14.96 | 4.63 | |
| 0.3 | 14.91 | 5.30 | |
| 0.4 | 14.84 | 5.84 | |
| 0.5 | 14.75 | 6.29 | |
| 0.6 | 14.64 | 6.68 | |
| 0.7 | 14.51 | 7.03 | |
| 0.8 | 14.36 | 7.35 | |
| 0.9 | 14.19 | 7.65 | |
| 1 | 14 | 7.92 | |
| 1.1 | 13.79 | 8.18 | |
| 1.2 | 13.56 | 8.42 | |
| 1.3 | 13.31 | 8.64 | |
| 1.4 | 13.04 | 8.86 | |
| 1.5 | 12.75 | 9.07 | |
| 1.6 | 12.44 | 9.26 | |
| 1.7 | 12.11 | 9.45 | |
| 1.8 | 11.76 | 9.63 | |
| 1.9 | 11.39 | 9.81 | |
| 2 | 11 | 9.98 | |
| 2.1 | 10.59 | 10.14 | |
| 2.2 | 10.16 | 10.30 | Qmax/Qo |
| 2.3 | 9.71 | 10.45 | |
| 2.4 | 9.24 | 10.60 | |
| 2.5 | 8.75 | 10.75 | |
| 2.6 | 8.24 | 10.89 | |
| 2.7 | 7.71 | 11.03 | |
| 2.8 | 7.16 | 11.16 | |
| 2.9 | 6.59 | 11.29 | |
| 3 | 6 | 11.42 | |

TABLE 2
Parameter

| | | |
|---|---|---|
| C1 | | 1500 |
| C2 | | 15 |
| C3 | | 1 |
| Delta | Step width Q/Qo | 0.1 |

| Q/Qo | H/Ho-Pump | H/Ho-DHV | |
|---|---|---|---|
| 0 | 15.0 | 0.0 | |
| 0.1 | 14.99 | 5.30 | |
| 0.2 | 14.96 | 6.68 | |
| 0.3 | 14.91 | 7.65 | |
| 0.4 | 14.84 | 8.42 | |
| 0.5 | 14.75 | 9.07 | |
| 0.6 | 14.64 | 9.63 | |
| 0.7 | 14.51 | 10.14 | |
| 0.8 | 14.36 | 10.60 | |
| 0.9 | 14.19 | 11.03 | |
| 1 | 14 | 11.42 | |
| 1.1 | 13.79 | 11.79 | |
| 1.2 | 13.56 | 12.13 | |
| 1.3 | 13.31 | 12.46 | |
| 1.4 | 13.04 | 12.77 | |
| 1.5 | 12.75 | 13.07 | Qmax/Qo |
| 1.6 | 12.44 | 13.35 | |
| 1.7 | 12.11 | 13.63 | |
| 1.8 | 11.76 | 13.89 | |
| 1.9 | 11.39 | 14.14 | |
| 2 | 11 | 14.38 | |
| 2.1 | 10.59 | 14.62 | |
| 2.2 | 10.16 | 14.85 | |
| 2.3 | 9.71 | 15.07 | |
| 2.4 | 9.24 | 15.28 | |
| 2.5 | 8.75 | 15.49 | |
| 2.6 | 8.24 | 15.70 | |
| 2.7 | 7.71 | 15.90 | |
| 2.8 | 7.16 | 16.09 | |
| 2.9 | 6.59 | 16.28 | |
| 3 | 6 | 16.46 | |

TABLE 3
Parameter

| | | |
|---|---|---|
| C1 | | 7000 |
| C2 | | 25 |
| C3 | | 1.1 |
| Delta | Step width Q/Qo | 0.15 |

| Q/Qo | H/Ho-Pumpe | H/Ho-DHV | |
|---|---|---|---|
| 0 | 25.0 | 0.00 | |
| 0.15 | 25.0 | 10.14 | |
| 0.3 | 24.9 | 12.77 | |
| 0.45 | 24.8 | 14.62 | |
| 0.6 | 24.6 | 16.09 | |
| 0.75 | 24.4 | 17.33 | |
| 0.9 | 24.1 | 18.42 | |
| 1.05 | 23.8 | 19.39 | |
| 1.2 | 23.4 | 20.27 | |
| 1.35 | 23.0 | 21.08 | |
| 1.5 | 22.5 | 21.83 | |
| 1.65 | 22.0 | 22.53 | Qmax/Qo |
| 1.8 | 21.4 | 23.20 | |
| 1.95 | 20.8 | 23.82 | |
| 2.1 | 20.1 | 24.42 | |
| 2.25 | 19.4 | 24.99 | |
| 2.4 | 18.7 | 25.53 | |
| 2.55 | 17.8 | 26.05 | |
| 2.7 | 17.0 | 26.55 | |
| 2.85 | 16.1 | 27.03 | |
| 3 | 15.1 | 27.50 | |
| 3.15 | 14.1 | 27.95 | |
| 3.3 | 13.0 | 28.38 | |
| 3.45 | 11.9 | 28.81 | |
| 3.6 | 10.7 | 29.22 | |
| 3.75 | 9.5 | 29.62 | |
| 3.9 | 8.3 | 30.01 | |
| 4.05 | 7.0 | 30.39 | |
| 4.2 | 5.6 | 30.76 | |
| 4.35 | 4.2 | 31.12 | |
| 4.5 | 2.7 | 31.47 | |

The specification “Qmax/Qo” denotes the approximate position of the value at which the curves according to Formulas II and II intersect each other and in which the flow rate is controlled.

### LIST OF REFERENCE NUMBERS

1 Valve housing
2 Top
3 Inlet Bore
4 Bottom Side
5 Inner Bore
6 Sealing Surface
7 Sealing Disk
8 Closure Piston
9 Upper Part of Closure Piston
10 Edge
11 lower Part of Closure Piston
12 Compression Spring
13 Clamping Ring
14 Seeger Ring
15 Groove
16 Gap
17 Flange
17′ Flange
18 Flat Gasket
18′ Flat Gasket
19 Bolt
19′ Bolt
20 Cleavage Reactor
21 Gas Line
22 Condenssor
23 Condensate Line
24 Flow Rate Condensate
25 Condensate Collection Tank
26 Condensate
27 Liquid Level
28 Filling Stub for Poymerisation Inhibitor
29 Feeding Line for Stabilized Condensate
30 Flow Direction of Suction Line
31 Centrifugal Pump
32 Feeding Line on the Pressure Side of Centrifugal Pump
33 Rotameter
34 Pressure Holding and regulating Valve
35 Vakuum Line
36 Flow Direction to the Vacuum Distillation Column
37 Vacuum Distillation Column

1. Conveyor device for a vacuum distillation unit for readily decomposable and/or polymerizing mixtures, in particular acrolein, in which a precursor product formed in a precursor stage is pumped by a pump into a vacuum distillation column (37),
characterized in that
the pump comprises a hermetically sealed centrifugal pump (31) having a magnetic coupling, and that
a pressure holding and regulating valve (34) is provided between the radial centrifugal pump (31) and the vacuum distillation column (37), which is designed to regulate the flow rate of the radial centrifugal pump (31) to a predetermined value.

2. Conveyor device according to claim 1, wherein the predetermined relationship between the dimensionless delivery height H/Ho[m WS/1 mWS] and dimensionless delivery rate Q/Qo[m³/h/1 m³/h] in the radial centrifugal pump (31) is:
{H/Ho}=C2−C3*(Q/Qo)² (Formula II)
and the relationship between the dimensionless delivery height H/Ho[mWS/1 mWS] and dimensionless delivery rate Q/Qo[m³/h/1 m³/h] at the pressure holding and regulating valve (34) is:
{H/Ho}={C1*(Q/Qo)}^{0,333} (Formula III)
characterized in that by the choice of the constant C1, the intersection between the curves according to Formula II and Formula III is at the point corresponding to the desired flow rate of the mixture.

3. Conveyor device according to claim 1, characterized in that a rotameter (33) is arranged between the radial centrifugal pump (31) and the pressure holding and regulating valve (34).

4. Conveyor device according to claim 1, characterized in that the precursor stage comprises a cleavage reactor (20), a condenser (22) arranged downstream of the cleavage reactor (20) and a condensate collection tank (25) arranged downstream of the condenser (22) connected to an inlet of the radial centrifugal pump (31).

5. Conveyor device according to claim 1, characterized in that the pressure holding and regulating valve (34) comprises: a cylindrical valve housing (1) having a top (2), in which a central inlet bore (3) is provided with a diameter d1, and with a bottom (4), in which an inner bore (5) is provided, whose diameter d2 is greater than that of the diameter of the inlet bore (3) and which forms an outlet of the pressure holding and regulating valve, a closure piston (8) having an upper part (9), whose diameter d3 is smaller than the diameter d2 of the inner bore (5) and larger than the diameter d1 of the inlet bore (3), a freely movable, circular sealing disc (7) made of an elastomer between the closure piston (8) and an inner sealing surface (6) formed between the inner bore (5) and the inlet bore (3) on an inner side of the valve housing (1), and by a compression spring (12) which is supported in the inner bore (5) and presses the sealing washer (7) over the closure piston (8) against the inner sealing surface (6).

6. Conveyor device according to claim 5, characterized in that the sealing disc (7) has a diameter d4 which is greater than the diameter d1 of the inlet bore (3) plus the radial extent of the inner sealing surface (6), and which is smaller than the diameter d3 of an upper part (9) of the closure piston (8).

7. Conveyor device according to claim 5, characterized in that the upper side (2) and the lower side (4) of the valve housing (1) are designed as planar sealing surfaces.

8. Conveyor device according to claim 5, characterized in that gap (16) formed between the upper part (9) of the closure piston (8) and the inner bore (5) has a cross-sectional area corresponding to the cross-sectional area of the inlet bore (3).

9. Conveyor device according to claim 5, characterized in that the compression spring (12) is supported in the inner bore (5) by a Seeger-ring (14) arranged over a groove (15) in the inner bore (5).

10. Conveyor device according to claim 9, characterized in that between the Seeger-ring (14) and the compression spring (12) at least one clamping ring (13) is arranged for adjusting the bias of the compression spring (12).

11. Conveyor device according to claim 5, characterized in that the valve housing (1) and the closure piston (8) are made of metal.
